(19) United States
(12) Patent Application Publication
(10) Pub. No.: US 2026/0154114 A1
(43) Pub. Date: Jun. 4, 2026

(54) METHODS, ARCHITECTURES, APPARATUSES AND SYSTEMS FOR DISTRIBUTED ARTIFICIAL INTELLIGENCE

(71) Applicant: InterDigital CE Patent Holdings, SAS, Paris (FR)

(72) Inventors: Cyril Quinquis, MELESSE (FR); Stephane Onno, SAINT GREGOIRE (FR); Thierry Filoche, CHATEAUGIRON (FR)

(21) Appl. No.: 19/126,410

(22) PCT Filed: Nov. 3, 2023
(86) PCT No.: PCT/EP2023/080633

§ 371 Date: May 1, 2025

(30) Foreign Application Priority Data
Nov. 4, 2022 (EP) 22306667.1

(51) Int. Cl. G06F 9/50

(52) U.S. Cl. CPC G06F 9/5027

(57) ABSTRACT

Procedures, methods, architectures, apparatuses, systems, devices, and computer program products for distributed Artificial Intelligence, AI. A first device receives a representation of at least part of a machine learning model and information representing a plurality of split points, a split point representing a layer at which an intermediate result of execution of the machine learning model may be output to a second device, the intermediate result enabling execution of the machine learning model from the split point, determines a selected split point from the plurality of split points, processes input data using the AI/ML model up to the selected split point to obtain an intermediate result corresponding to the selected split point, and outputs, to the second device, information corresponding to the intermediate result corresponding to the selected split point and information indicating the selected split point.

### CROSS-REFERENCE TO OTHER APPLICATIONS

This application claims the priority to European Application No. 22306667.1, filed Nov. 4, 2022, which is incorporated herein by reference in its entirety.

### BACKGROUND

The present disclosure is generally directed to the fields of communications, software and encoding, including, for example, to methods, architectures, apparatuses, systems directed to collaborative Artificial Intelligence (AI).

### SUMMARY

In a first aspect, the present principles are directed to a method in a first device that receives a representation of at least part of a machine learning model and information representing a plurality of split points, a split point representing a layer at which an intermediate result of execution of the machine learning model may be output to a second device, the intermediate result enabling execution of the machine learning model from the split point, determines a selected split point from the plurality of split points, processes input data using the AI/ML model up to the selected split point to obtain an intermediate result corresponding to the selected split point, and outputs, to the second device, information corresponding to the intermediate result corresponding to the selected split point and information indicating the selected split point.

In a second aspect, the present principles are directed to a first device comprising at least one hardware processor configured to receive a representation of at least part of a machine learning model and information representing a plurality of split points, a split point representing a layer at which an intermediate result of execution of the machine learning model may be output to a second device, the intermediate result enabling execution of the machine learning model from the split point, determine a selected split point from the plurality of split points, process input data using the machine learning model up to the selected split point to obtain an intermediate result corresponding to the selected split point, and output, to the second device, information corresponding to the intermediate result corresponding to the selected split point and information indicating the selected split point.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system:

FIG. 1B is a system diagram illustrating an example wireless transmit/receive unit (WTRU) that may be used within the communications system illustrated in FIG. 1A:

FIG. 1C is a system diagram illustrating an example radio access network (RAN) and an example core network (CN) that may be used within the communications system illustrated in FIG. 1A:

FIG. 1D is a system diagram illustrating a further example RAN and a further example CN that may be used within the communications system illustrated in FIG. 1A;

FIG. 2 illustrates split of an AI/ML model into parts:

FIG. 3 illustrates an example of a representation of a model:

FIG. 4 illustrates a representation of a model with potential split points:

FIG. 5 illustrates a system according to an embodiment of the present principles:

FIG. 6 illustrates overlapping split points at the UE and the network according to an embodiment of the present principles:

FIGS. 7A and 7B illustrate examples of processing in a pipeline according to embodiments of the present principles:

FIG. 8 illustrates a flow chart of a deployment and provisioning method according to an embodiment of the present principles; and

FIG. 9 illustrates a sequence diagram of an embodiment according to the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

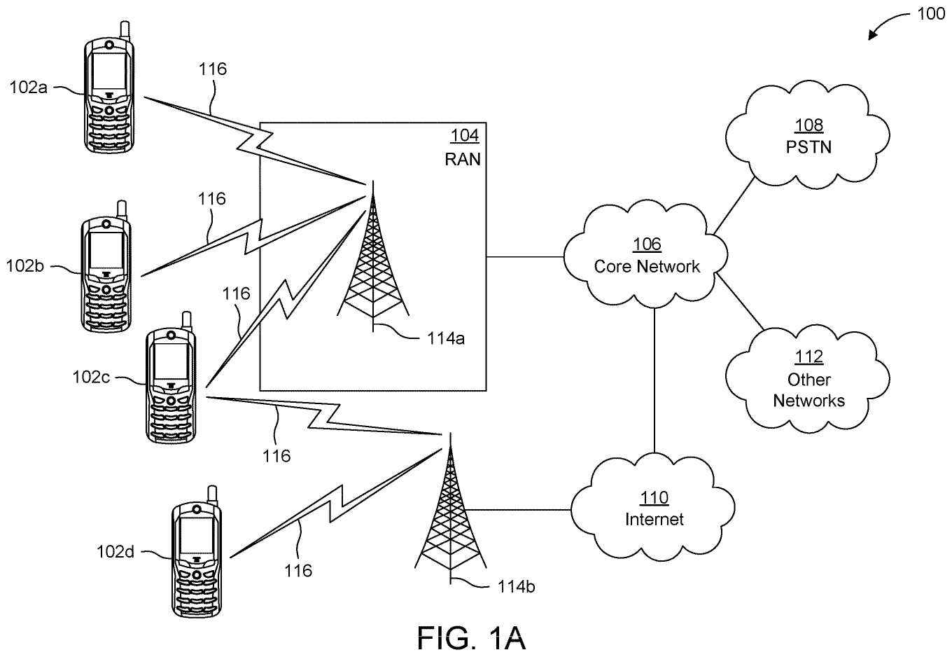

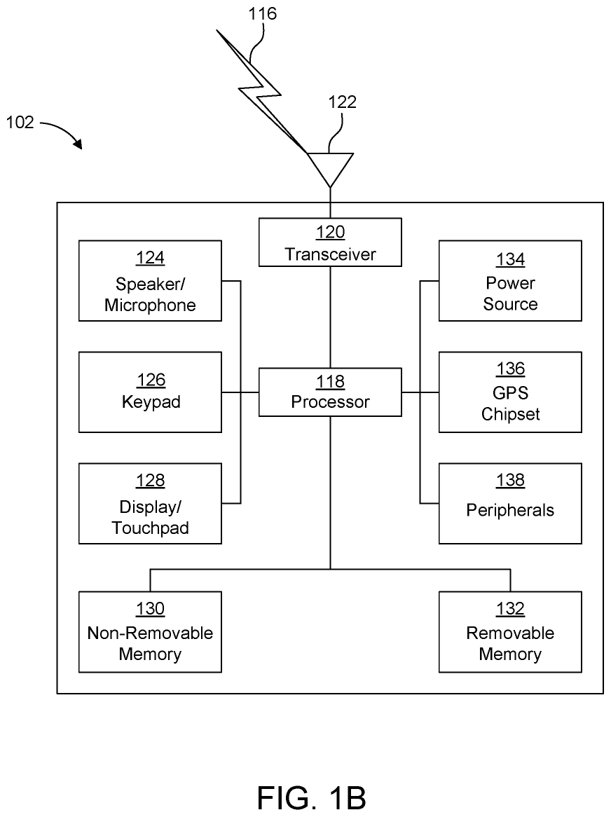

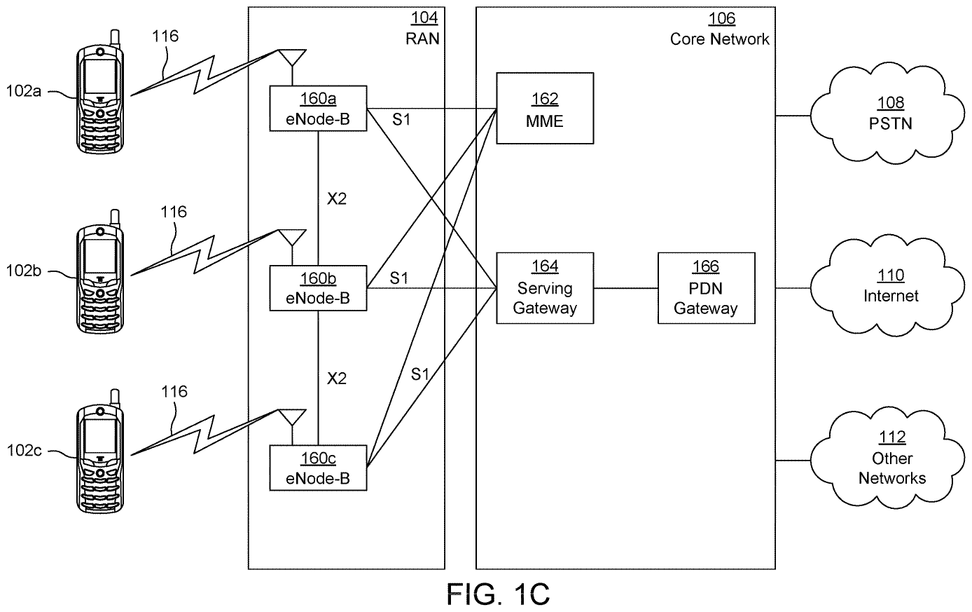

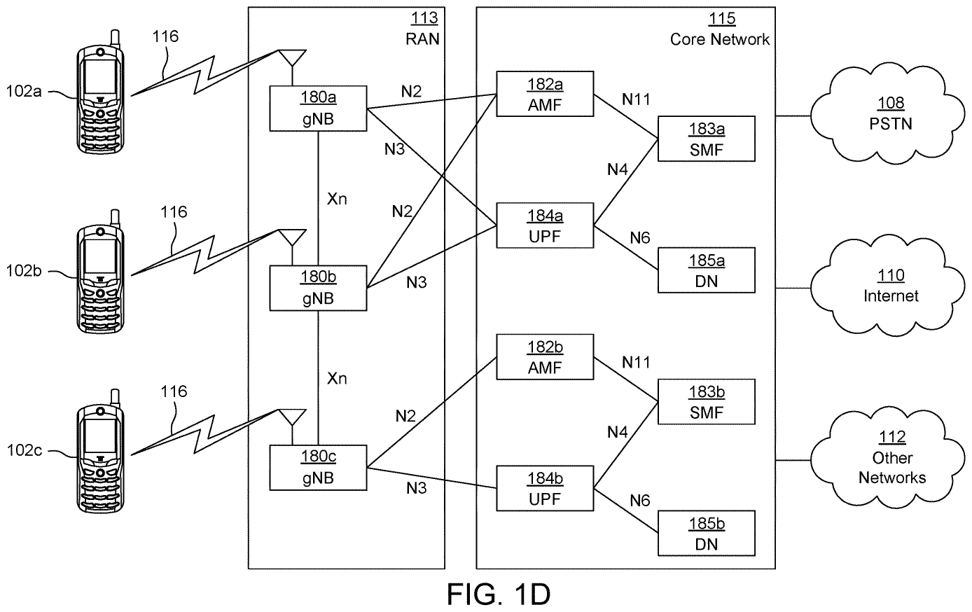

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUS 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor: a geolocation sensor: an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a. 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Distributed inference (i.e., split computing) can be used to distribute the computing load across a mobile device, UE, and one or more remote (e.g., edge or cloud) devices (e.g., servers), to move part of the energy consumption from the UE to the remote devices, and to help preserve privacy by transmitting partially processed data rather than raw data.

The achieve distributed inference, an AI/ML model, e.g., a Distributed Neural Network (DNN) model, is partitioned into multiple parts. The partition may be made according to current system environment factors such as network bandwidth, device resources (memory, power, processing units) and remote device workload.

The UE executes the DNN model up to a specific layer and sends resulting intermediate data to the remote device that executes the remaining layers and sends the result back to the UE.

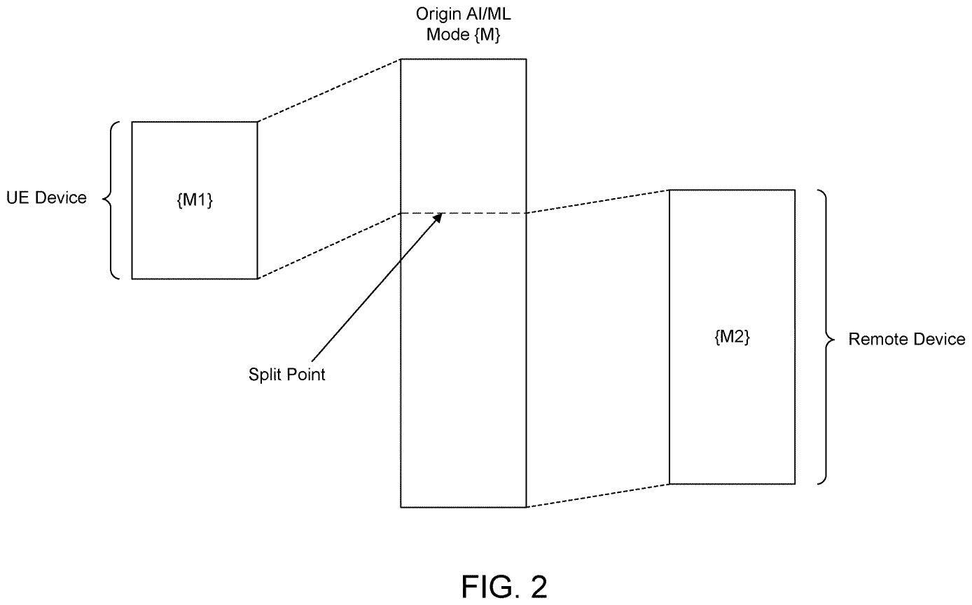

FIG. 2 illustrates split of an AI/ML model into parts. The original model {M} is split at a split point into a first part {M1} to be executed by the UE and a second part {M2} to be executed by the remote device. Depending on where the model is split, its parts are if needed transmitted the UE, the remote device or both.

A split point can be indicated in different ways, for example depending on how the model is expressed. As an example, in Keras, an open-source software library, the layers of a model are stored in a sequential list, and an index or a list of indices may be used to indicate a split point.

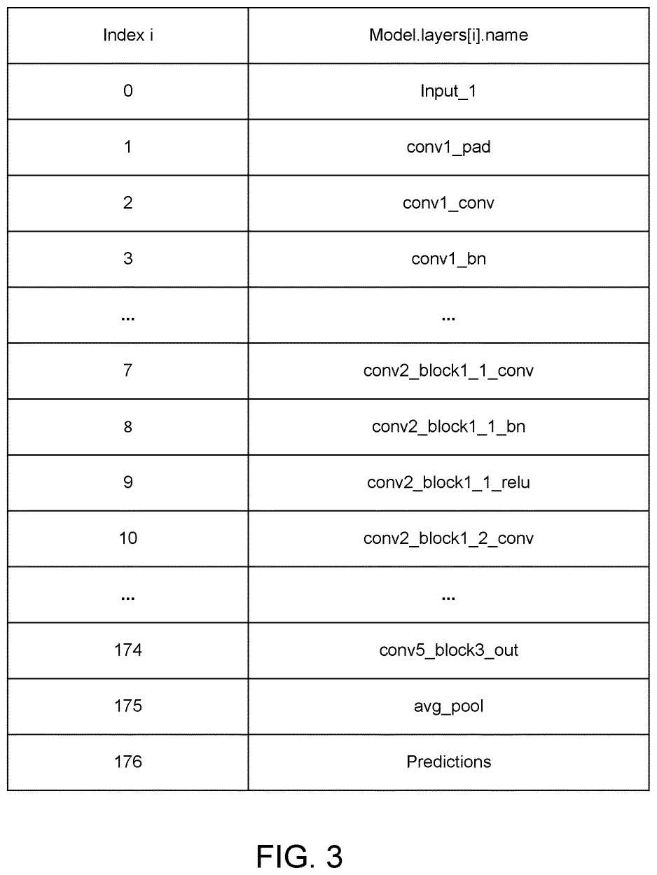

FIG. 3 illustrates an example of a representation of a model, ResNet50, a type of artificial neural network, structured as model.layers[:]. Since the layer names are unique, these can be used instead of, or in addition to, an index to indicate a split point.

Similar ways to indicate split points are available for other frameworks such as ONNX and NNEF.

For each layer, there is also an indication of the layer or layers that provide the input to the layer.

One way of splitting a model into parts is to decompose the model into autonomous blocks and then define a part as one or more blocks. A model may for example be cut after a layer receiving input from a plurality of layers or after a layer providing output to a plurality of layers

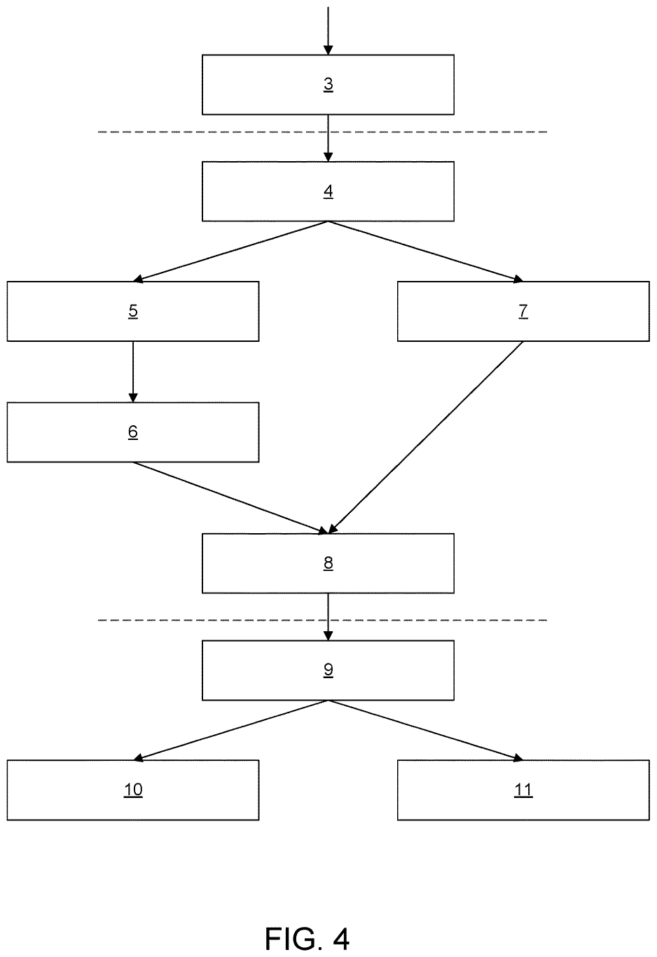

FIG. 4 illustrates a representation of a model with potential split points. As can be seen, layer 4 provides output to layers 5 and 7, layer 8 receives input from layers 6 and 7, and layer 9 provides output to layers 10 and 11. A split point (indicated by a dashed line) may thus be determined between layers 3 and 4, since layer 4 provides output to a plurality of layers. In a similar way, another split point may be determined between layers 8 and 9, since layer 8 receives input from a plurality of layers and/or since layer 9 provides output to a plurality of layers.

A block thus has an input layer and an output layer. The input layer may be defined by its index or name. The data input characteristics (data dimension) of the input layer has the same characteristics (data dimension) as the output of the previous branch (or, for the first layer of the model, the dimension of the expected input data). The output layer may be defined by its name and index. The output layer has its data output characteristics (data dimension).

Inside the block, between the input layer and the output layer, any combination of layers may be present provided there is no reference to an external layer (e.g., a layer present in another branch). Put another way, except for the input and the output, the block is autonomous (i.e., independent).

In addition to data input characteristics and data output characteristics, the block may also be associated with additional information such as inference complexity and energy indication. The inference complexity may be absolute for a specific device or relative to the total inference time requested by a model running on a reference device. The energy indication may be absolute for a specific device or relative to the total energy requested by a model running on a reference device.

For ease of illustration, the description is limited to splitting a model into two parts. It will however be understood that a model may be split into further parts, for example from the outset, but it is also possible to split a model into two parts and then subdivide a part into further parts.

With two parts, the first part includes the original input_layer, and the second part includes the last layer (e.g., “predictions” layer for ResNet50).

The split point may be indicated using the index or layer name of the layer just before the split point. In the example of FIG. 4, the first split point may be indicated as 3, and the second as 8. It is also possible to indicate the split point using the index or layer name of the layer just after the split point, e.g., 4 or 9 in the example in FIG. 4.

The split parts may be defined by their constituent layers, for example a first part {M1} may then be defined as {1,3} and the second part {M2} as {4,X} in the example of FIG. 4. The output layer of M1 is layer 3 and the input layer of M2 is layer 4.

The choice of the split point(s) may be made by a decision module managed by an operator or provider of the AI/ML application. The decision module may inform the UE and the remote device about the chosen split point and hence about the parts to be used by each entity. Depending on the implementation, the decision module can be called “scheduler”, “optimizer”, “profiler”, “evaluator” or “referee”.

For the decision, the decision module may consider one or more requirements, such as latency requirements, energy requirements and throughput requirements. To meet the requirement(s), the decision module processes information provided by the operator, the AI/ML application provider, remote devices and/or the UE to determine the split point.

The network infrastructure nodes, i.e., the UE and the remote device, are provisioned with the AI/ML model partitions according to the split point. The inference process can then start.

The size of the intermediate data output by the UE and transmitted to the remote device corresponds to the size of the M1 output data and typically depends on the chosen split point.

The UE may contain all possible M1 and the remote device all possible M2, which makes it sufficient to transmit an identifier of the chosen parts, for example by transmitting an identifier of the split point.

A drawback of this solution is that the UE and the remote devices respectively store all possible parts M1 and M2, which is detrimental to memory efficiency, especially at the UE.

Another drawback is that the granularity can be coarse. When a change of split point happens, it requires to load a new model into the processor memory, causing a waste of time and possibly loss of data and interruption of service since processing is paused during loading.

It is also noted that the solution can be defined as a static implementation in which the split point decision is external to the UE. However, as mentioned, a change of split point may require an update of the partitioned model with loading or downloading operations that take time. Other expressions for “static implementation” are “frozen implementation,” “non-flexible management” and “pre-configured implementation”.

It will be understood that locating the decision module in the network can mean that it only has a limited level of information to define the split point. Moreover, node environment parameters may fluctuate in time. In other words, the split point management described before may be inefficient.

In more detail, the decision where to split the AI/ML model is often based on general and well-known requirements such as latency, energy consumption and/or bandwidth. In some circumstances, these requirements are not sufficient and further UE-specific parameters may have a significant impact on the choice of the split point, e.g., privacy settings, constructor or manufacturer-specific HW or SW settings and user profile.

For different reasons, these UE-specific parameters can be restricted to the UE and consequently the network decision module cannot consider them. Reasons for restricting the parameters to the UE include that the end user does not want to transmit the user profile or that the UE manufacturer does not want to transmit the HW/SW settings.

It will also be understood that changing the split point can require updating the partitioned AI/ML model on the UE. An update can require swapping the partitioned model or downloading the adequate partitioned model, which may be slow and may also introduce latency during the inference process.

In more detail, if the UE uses a partitioned model that infers an input video stream with a given frame rate and, during the inference process the split point changes, the already described split point management may result in the loss of frames, which in turn may generate an interruption of service.

According to the present principles, the UE manages a set of split points defined by the network and can select the split point. The UE can process its part of the model and then transmit to the network the resulting intermediate data together with additional information (e.g., split point ID, sequence number, timestamp).

Further, the partitioned AI/ML model on the UE works as a pipeline. The partitioned AI/ML model may be loaded once and all the corresponding parts may be available at any time, which means that almost as soon as a split point is selected, the corresponding part is operational and may be fed with sequential data such as a video bitstream. A reason for this is that it can be sufficient to store the partitioned AI/ML model and the corresponding split points, e.g. [A], [B] and so on, as opposed to storing partitions up to each split point.

According to the present principles, the partition point of the model is not unique, but there are multiple possible split points with a dynamic management that relies on a local decision module in the UE. Among the plurality of split points, a given split point may be indicated as preferred. There may also be a ranking (e.g., decreasing) of at least two of the plurality of split points.

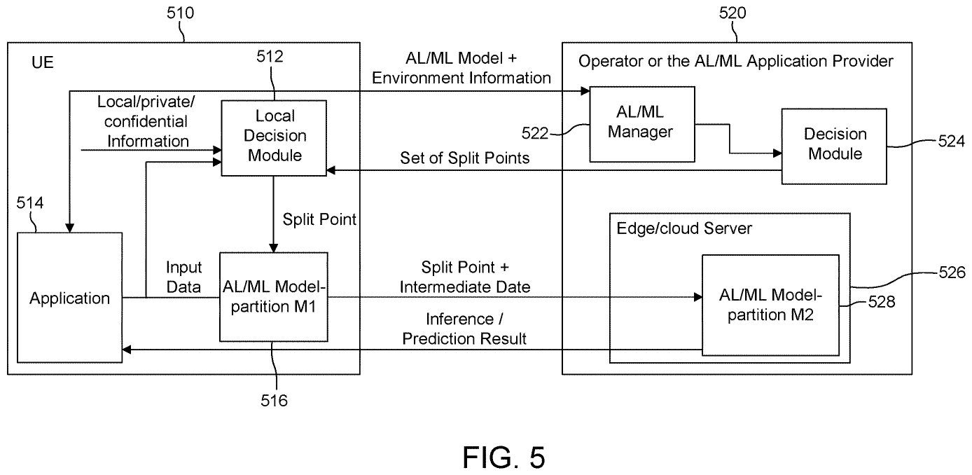

FIG. 5 illustrates a system according to an embodiment of the present principles. A local decision module 512 in the UE 510 may monitor local settings/information to be considered, e.g. received from an application 514, when determining the split point and may also consider the input data to be inferred, e.g., the amount of data, the input frame rate or the number of data flows. In an embodiment, the local decision module 512 can be triggered by another module (not shown).

If the split point needs to be changed, the external decision module 524 transmits the information to the UE 510 so that the split point is updated. The local decision module 512 considers the information and may decide to apply the changed split point to the next incoming data.

The split point used by the UE 510 is communicated to a remote device 526 (e.g., edge or cloud server) with the associated intermediate data. Upon reception, the remote device 526 may dynamically redefine the M2 part 528 of the model.

When deploying the partitioned model(s) over the network nodes (e.g., UE, edge server or cloud server), a set of partition points is transmitted from network side to the UE side, for example by the application provider 520. The set of split points may be transmitted as a list, as a range or as a simple max boundary.

The set of split points can give flexibility or freedom to the UE 510 to choose the split point according to its own policy. Indeed, some device/SW implementers may emphasize the power consumption parameter, and others the latency, the privacy, or other confidential considerations.

The AI/ML model part hosted by the UE 510 comprises different points where the model can be divided into parts. If the split point changes for one inferer, for example the UE, the split point for the other inferer, for example the edge server or the cloud server, shall change accordingly and synchronously, which can be made possible using messages preceding or attached to the intermediate data.

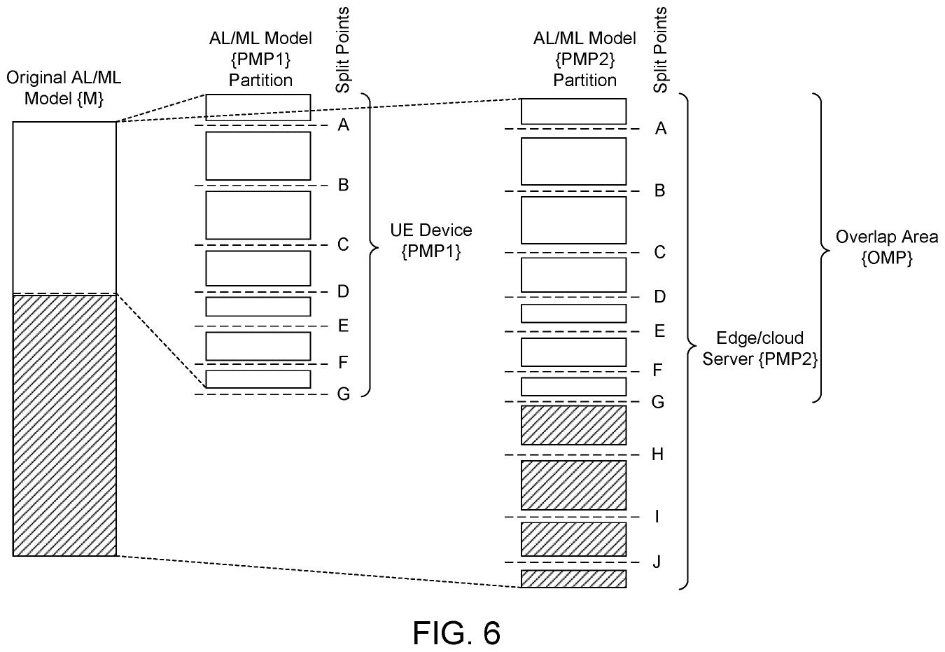

FIG. 6 illustrates overlapping split points at the UE and the network according to an embodiment of the present principles.

A change of split point requires that the split point exists on both sides. If not, the missing AI/ML model part must be downloaded, which could delay the inference process.

As illustrated in FIG. 6, there is an original model M with two sections (Potential Model Partitions, PMPs): a first section (white) residing on both the UE and the external device, and a second section (grey) residing only on the external device. Also illustrated are a number of split points A-J of which A-F are in the first section, G is between the two sections, and H-J are in the second section.

The UE may select/change/update the split point within the limits (list, range, boundary) given by the AI/ML model management entity, i.e., by selecting one of the given split points. Since the UE only has the first section, it can only select between split points A-G (or download at least some of the second section).

The AI/ML model manager aims at managing the AI/ML models on the UEs, the edge and cloud servers. To this end, it may deliver information on how to download AI/ML models, how to update them, how to process them, what is their architecture, etc.

The set of split points transmitted to the UE could take the form of for example a range of split points, a list of split points, or a split point max boundary. In addition, a preferred split point or a ranking of split points can be transmitted.

A range of split points is thus set and transmitted to the UE that then may determine the split point to use based on for example environment parameters and/or device-specific parameters.

When the split point is selected, the UE informs the external device that updates its split point accordingly.

As external devices such as edge/cloud servers typically can rely on important resources (power, processing units), their sections can gather a maximum of split points, up to and including storing the whole AI/ML model. Then depending on the choice of the split point, only a part is used. Thus, external devices can be provisioned with the second section PMP2.

On the UE side, the resources are limited, and it may therefore not be possible to provision the UE with the full AI/ML model and all the split points. Nevertheless, the AI/ML model partition can be dimensioned to the maximum available capacity of the UE in terms of memory and/or processing units. Thus, the UE can be provisioned with the first section PMP1, and a list of the applicable split points or a range of split points or a maximum boundary for the split points.

The split points transmitted to the UE overlaps with the split points of the external device, which make selection of a common split point.

The network may transmit the set of split points to the UE in a number of ways.

The network may transmit a range of split points to the UE. For example, in the example illustrated in FIG. 6, the network may transmit the range [A, G], i.e., all the split points of the first section to the UE. The network may also transmit a subset of all possible split points, for example [B, F] to the UE.

The network may also transmit a list of split points to the UE. The list may be at least partly non-contiguous. For example, in FIG. 6, the possible split points are A-G and a selection of these, for example {B, D, F} can be provided to the UE. This means that split points A, C, E and G are not provided to the UE. This may for instance be the case if the intermediate data from these split points are too big or if they are susceptible to a malicious attack.

The network may also transmit a maximum boundary of split points to the UE. The maximum boundary indicates the upper limit to the split points that may be selected. For example, in FIG. 6, the network may determine that split point D is the highest that may be chosen by the UE. The UE may then select the split point among split points A, B, C and D.

Continuing the example in FIG. 6, it is assumed that each part is independent of the other parts and that the UE determines the split point to be D.

The UE executes each part sequentially until split point D is reached. The UE may check after each processed part if the split point has been reached, but it may also know the layers to process to arrive at split point D.

Upon reaching the split point, the UE encapsulates the intermediate result data in a message with a header indicating the source of the message and the split point. The UE then transmits the message to the network, i.e., the external device.

The external device receives the encapsulated intermediate result, extracts the intermediate result data, obtains the split point and the next part to execute, and processes the intermediate result data in the obtained part. Then output data of part is provided to the next part until the end and the prediction layer outputs a result.

Intermediate result data may be encapsulated in a message indicating the origin of the data. The message may for example have the following structure:

Struct IntermediateDataWrapper {

| | | |
|---|---|---|
| Int | Model_RefID; | # Model Identifier |
| bit | ChangeOfSplitPoint; | # 1 if the splitpoint is changed from the |

previous message

| IntSplitPointID; | | # Split point used by the UE |
|---|---|---|
| Int NextSplitpointID; | | # Next split point used by the UE (optional) |
| Int | IntermediateDataLength; | # Length of Intermediate Data |
| Dim | IntermediateDataDim; | # Array dimension of intermediate data |
| byte | EncodingMethod; | # Indicate if data are compressed and by which |

algorithm

| | | |
|---|---|---|
| int | SequenceNumber; | # Sequential identifier of input data |
| double | TimeStamp; | # Timestamp of the intermediate data |
| Byte | IntermediateData[ ] | # Intermediate Data |

};

In case the UE and the external device have enough memory to store all the possibilities of M1 and M2, the UE may transmit information indicating the used part that obtained the intermediate result. The external device can retrieve this information and activate the corresponding part to finish the inference.

### Split Point Inference of a Video Stream

Each frame i of the video stream is processed using the layers on the UE and the resulting intermediate data associated with the frame is transmitted to the external device accompanied by information indicating the split point. It will be understood that the processing can be seen as a pipeline.

In an embodiment, the video stream is processed one frame at a time. The next frame is processed when the processing of the previous frame is ended, i.e., when an intermediate result has been obtained.

In case the UE determines to change split point during processing of the video stream, it is sufficient to indicate the changed split point in the information accompanying the intermediate data associated with the frame.

In an embodiment, a plurality of frames are processed simultaneously by the UE and possibly also on the external device (that, if it is quick enough, may process the frames one by one). This approach typically has a higher throughput than when frames are processed one at a time.

On the UE, each block may process one frame. When a block has processed a frame, the result is provided to the next block and the block may receive the output of the previous block.

In case the UE determines to change split point during processing of the video stream, there are a number of possibilities to inform the external device.

If a main priority of the processing is not to lose a frame, the UE may wait until an impacted layer has finished its processing. Then, the split point may be changed to exclude processing by the impacted layer at the UE.

If a main priority is the latency, currently processed frames may simply be skipped and inference may continue with new incoming frames.

Using timestamps, the two solutions can be combined. The processed frames are transmitted with a timestamp and/or a sequence number. The external device may the determine whether to skip or to process the delayed frame(s), for example based on the timestamp and/or the sequence number.

It is noted that the throughput rate, be it when processing one frame at a time or a plurality of frames, provides the maximum frame rate allowed by the model.

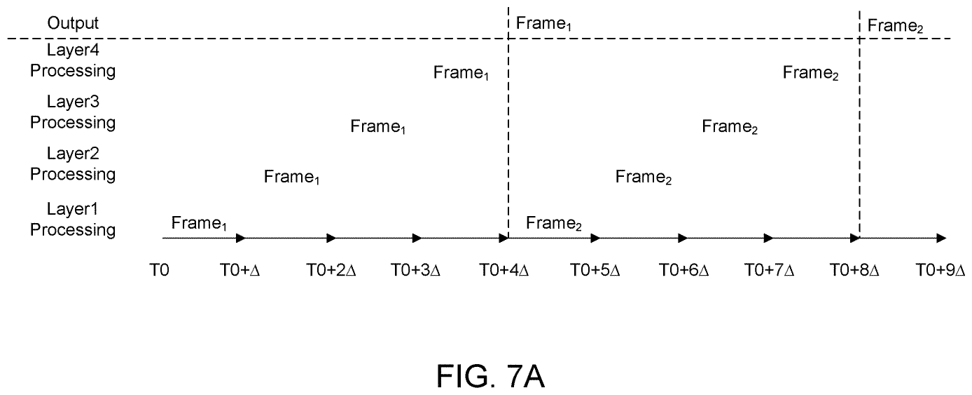

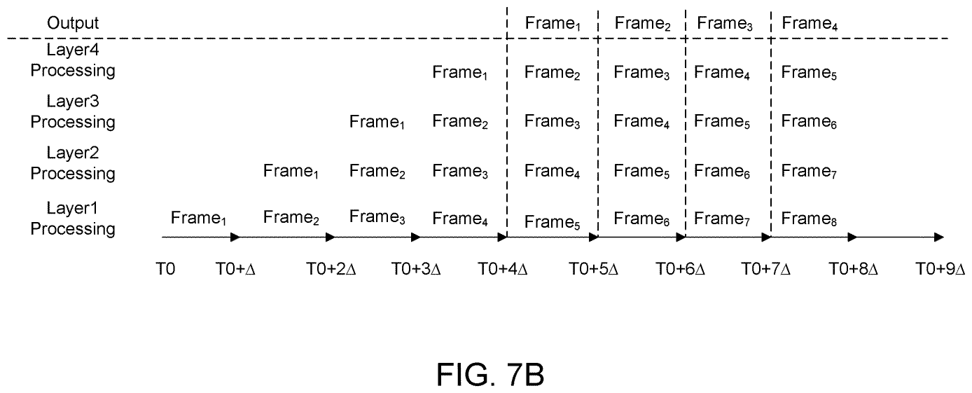

FIG. 7A illustrates an example of sequential pipeline processing according to an embodiment. In the example, the AI/ML model part includes four layers that each process and output frame data within a time Δ. At T0, layer 1 starts processing a first frame, Frame₁, that is passed to layer 2 that starts processing at T0+Δ and so on until the result for Frame₁ is output at T0+4Δ. Then a second frame Frame₂ is processed the same way beginning at T0+4Δ until the result is output at T0+8Δ.

FIG. 7B illustrates an example of parallel pipeline processing according to an embodiment. In the example, the AI/ML model part includes four layers that each process and output frame data within a time Δ. At T0, layer 1 starts processing a first frame, Frame₁, that is passed to layer 2 that starts processing at T0+Δ and so on until the result for Frame₁ is output at T0+4Δ. However, different from FIG. 7A, processing of the second frame Frame₂ begins when layer 1 has produced the result of Frame₁, i.e. at T0+Δ. As can be seen, apart from the ramp-up period, parallel processing can produce four times the output of sequential processing.

Pipelining the partitioned model can have an advantage in that each block can be deployed on a specific hardware unit: for example, CPU, GPU, NPU, TPU. One block may for example advantageously run on a TPU while another is more suitable to be processed on a GPU.

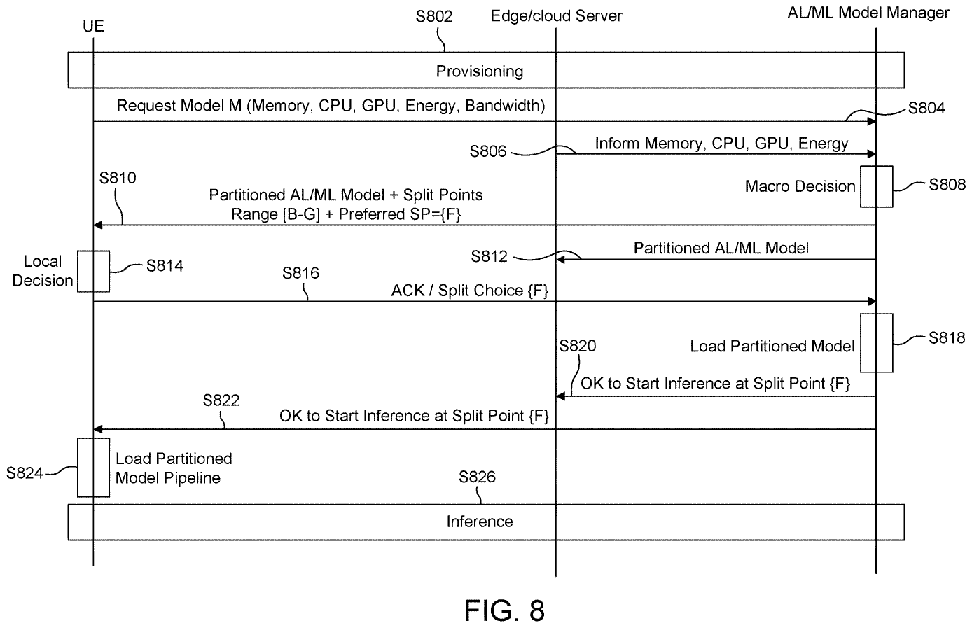

FIG. 8 illustrates a flow chart of a deployment and provisioning method according to an embodiment of the present principles. Among other things, FIG. 8 illustrates messages exchanged between UE 801, the AI/ML model manager 805 and the external devices 803.

The AI/ML model manager 805 manages the AI/ML model resources. It gathers information coming from the UE 801 and the external devices 803, processes the information and determines the AI/ML model partitions: size of each partition and split points, i.e., the way the model is partitioned.

The information may include, but not limited to, bandwidth measured by the UE and/or the Base Station (and communicated to the UE), power consumption (energy) on the UE and/or the external devices, and processing units available on the UE and/or the external devices.

The external devices 803 are nodes on which the second part of the AI/ML model is processed.

After provisioning in step S802, the UE requests, in step S804, from the AI/ML model manager 805 an AI/ML model in a request including information such as, as already described, its processing unit state, its memory state, and the available bandwidth on its wireless link. The external devices 803 transmit, in step S806, information about their processing units, memory and energy capabilities.

The AI/ML model manager 805 processes the information and determines, in step S808, how to distribute the AI/ML model parts, i.e., in terms of partition, but also which split point range the UE can use.

The AI/ML model manager 805 transmits, in step S810, the partitioned model to use, the split point range, e.g. [B-G] and a preferred split point, e.g. {F}. The partitioned model transmitted by the AI/ML model manager 805 includes in a plurality of blocks as illustrated in FIG. 6 where each block includes at least one layer and one input layer.

The UE 801 runs, in step S814, its own local decision module based on its own information and on the provided split point range. The also UE acknowledges, in step S816, the reception of the partitioned model.

In step S818, the network starts loading the partitioned model and then, in step S820, transmits to the UE 801 information indicating that the inference can start.

In step S824, the UE 801 loads the partitioned model and inference begins in step S826.

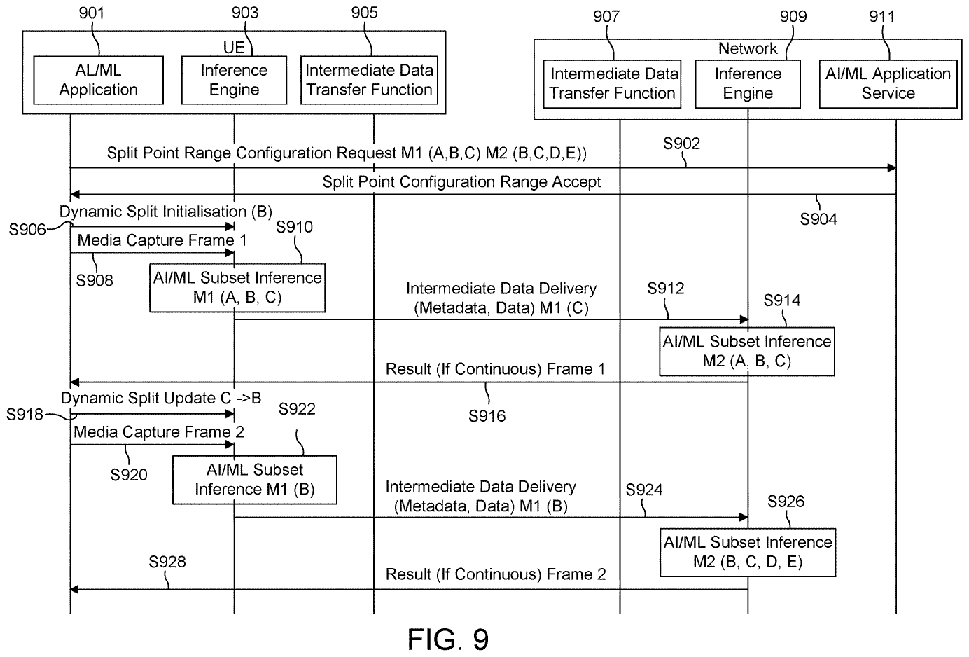

FIG. 9 illustrates a sequence diagram of an embodiment compatible with current 3GPP SA4 AI/ML components according to the present principles.

In step S902, the AI/ML application 901 sends a request for a dynamic split configuration range from the AI/ML application service 911. The request proposes a dynamic split of the AI/ML model (e.g., M) into two parts (e.g., M1 and M2) at different split points (e.g. A, B, C, D, E), with M1 being executed on the UE and M2 in the network. For example, here, split points B and C can be considered for both sides.

In step S904, the AI/ML application service 911 sends a message to inform the AI/ML application 901 that the request has been granted.

In step S906, the AI/ML application 901 computes a split point based on, for example, internal resources and application requirements, and initializes the AI/ML UE subset including split points A, B and C.

In step S908, the inference engine 903 receives the first sequence, Frame 1.

In step S910, the inference engine 903 processes Frame 1 up to split point C.

In step S912, the inference engine 903 sends the intermediate result for Frame 1 to the intermediate data transfer function 905 that transmits a message including the intermediate result and metadata to the network inference engine 909 via the intermediate data transfer function 907. The metadata includes an indication of the used split point.

In step S914, the network inference engine 909 processes the intermediate result for Frame 1 using M2 from split point C.

In step S916, the network inference engine 909 transmits a message with the result for Frame 1 to the AI/ML application 901.

In step S918, the AI/ML application 901, having determined a new split point, B, informs the inference engine 903 of the new split point. The determination of the new split point may depend on internal triggers (e.g., decreasing available processing power).

In step S920, the inference engine 903 receives the second sequence, Frame 2.

In step S922, the inference engine 903 processes Frame 2 up to split point B.

In step S924, the inference engine 903 sends the intermediate result for Frame 2 to the intermediate data transfer function 905 that transmits a message including the intermediate result and metadata to the network inference engine 909 via the intermediate data transfer function 907. The metadata includes an indication of the used split point.

In step S926, based on the received indication of the split point, the network inference engine 909 changes its own split point (and AI/ML model part) and processes the intermediate result for Frame 2 from split point B.

In step S928, the network inference engine 909 transmits a message with the result for Frame 2 to the AI/ML application 901.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU): (ii) any of a number of embodiments of a WTRU: (iii) a wireless-capable and/or wired-capable (e.g., tetherable) device configured with, inter alia, some or all structures and functionality of a WTRU: (iii) a wireless-capable and/or wired-capable device configured with less than all structures and functionality of a WTRU: or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method comprising in a first device:
receiving a representation of at least part of a machine learning model and information representing a plurality of split points, a split point representing a layer at which an intermediate result of execution of the machine learning model may be output to a second device, the intermediate result enabling execution of the machine learning model from the split point;
determining a selected split point from the plurality of split points;
processing input data using the machine learning model up to the selected split point to obtain an intermediate result corresponding to the selected split point; and
outputting, to the second device, the intermediate result corresponding to the selected split point and information indicating the selected split point.

2. The method of claim 1, comprising:
receiving, from the second device, a result of execution of the machine learning model from the selected split point.

3. The method of claim 1, wherein:
the layer is the layer in the machine learning model that outputs the intermediate result corresponding to the selected split point.

4. (canceled)

5. A first device comprising at least one hardware processor configured to:
receive a representation of at least part of a machine learning model and information representing a plurality of split points, a split point representing a layer at which an intermediate result of execution of the machine learning model may be output to a second device, the intermediate result enabling execution of the machine learning model from the split point;
determine a selected split point from the plurality of split points;
process input data using the machine learning model up to the selected split point to obtain an intermediate result corresponding to the selected split point; and
output, to the second device, the intermediate result corresponding to the selected split point and information indicating the selected split point.

6. The first device of claim 5, wherein the at least one hardware processor is further configured to:
receive, from the second device, a result of execution of the machine learning model from the selected split point.

7. The first device of claim 5, wherein:
the layer is the layer in the machine learning model that outputs the intermediate result corresponding to the selected split point.

8. (canceled)

9. The method of claim 1, comprising:
determining a further selected split point from the plurality of split points;
processing further input data using the machine learning model up to the further selected split point to obtain a further intermediate result corresponding to the further selected split point; and
outputting, to the second device, the further intermediate result corresponding to the further selected split point and information indicating the further selected split point.

10. The method of claim 9, wherein:
the input data and the further input data are different frames of a video stream.

11. The first device of claim 5, comprising:
determining a further selected split point from the plurality of split points;
processing further input data using the machine learning model up to the further selected split point to obtain a further intermediate result corresponding to the further selected split point; and
outputting, to the second device, the further intermediate result corresponding to the further selected split point and information indicating the further selected split point.

12. The first device of claim 11, wherein:
the input data and the further input data are different frames of a video stream.
